(19) United States
(12) Patent Application Publication
(10) Pub. No.: US 2009/0103909 A1
(43) Pub. Date: Apr. 23, 2009

(54) Aerial camera support structure

(75) Inventors: Gary D. Giegerich, Glenside, PA (US); Edmond J. Dougherty, Wayne, PA (US)

Correspondence Address: PANITCH SCHWARZE BELISARIO & NADEL LLP, ONE COMMERCE SQUARE, 2005 MARKET STREET, SUITE 2200, PHILADELPHIA, PA, 19103, US

(73) Assignee: Live Event Media, Inc., Fort Washington, PA (US)

(21) Appl. No.: 12/288,220

(22) Filed: Oct. 17, 2008

Related U.S. Application Data
(60) Provisional application No. 60/980,605, filed on Oct. 17, 2007.

(51) Int. Cl. G03B 17/00

(52) U.S. Cl. 396/12

(57) ABSTRACT

An aerial support structure for capturing images of objects in an observed area includes first and second anchors and at least one transport cable mounted to at least one of the first and second anchor. A balloon is mounted to the at least one transport cable and is movable relative to the first and second anchors. A camera is suspended from the balloon.

### CROSS-REFERENCE TO RELATED APPLICATIONS

This application claims the benefit of U.S. Provisional Patent Application No. 60/980,605 filed Oct. 17, 2007 entitled “Balloon-Borne Support Structure and Method for Image Capture,” incorporated by reference herein in its entirety.

### BACKGROUND OF THE INVENTION

The present invention is directed to an aerial camera support structure for capturing images of objects, persons or fans, preferably at indoor and outdoor stadiums or arenas, but may also be utilized to capture images over a larger area such as a campus, park, military installation, office park, cargo terminal or other similar area.

Several varieties of aerial camera support structures and methods for image capturing are well known. For example, mounting a camera to a moving platform to provide various vantage points for capturing images using the camera is known. In addition, suspending a camera from various cables in a venue, such as the SkyCam® or as described in U.S. Patent Application Publication No. 2007/0064208, to provide variable vantage points for capturing images using the camera in a venue is known. Such known support structures and methods for image capture are typically difficult to construct and employ, are often expensive and may provide a distraction or obstacle for observers at an event in specific types of settings.

It would be desirable to provide an apparatus for capturing images that reduces the tension on the support cables, provides for image capturing stability and is kept substantially out of the line of sight of spectators.

### BRIEF SUMMARY OF THE INVENTION

Briefly stated, the present invention is directed to an aerial support structure for capturing images of objects in an observed area. The cable camera support structure comprises first and second anchors and at least one transport cable mounted to at least one of the first and second anchor. A balloon is mounted to the at least one transport cable and is movable relative to the first and second anchors. A camera is suspended from the balloon.

In another aspect, the invention is directed to an aerial support structure for capturing images of objects in a venue having a field of play. The cable mounted camera support structure comprises first, second and third anchors fixedly mounted to the venue. First, second and third transport cables each have a first end mounted to a respective anchor. A balloon is mounted on a camera axis and to a second end of each of the transport cables. The transport cables move the balloon relative to the first, second and third anchors above the field of play. A support platform is mounted to the balloon and positioned at least partially between the bottom and top of the balloon. A plurality of winches are mounted to the support platform. A camera is suspended and axially spaced from the balloon and the support platform along the camera axis by a plurality of support cables. A first end of each of the support cables are connected to one of the plurality of winches and a second end of each of the support cables are connected to the camera. Each of the plurality of support cables define a support angle relative to the camera axis.

### BRIEF DESCRIPTION OF THE SEVERAL VIEWS OF THE DRAWINGS

The foregoing summary, as well as the following detailed description of a preferred embodiment of the invention, will be better understood when read in conjunction with the appended drawings. For the purpose of illustrating the invention, there is shown in the drawings embodiments which are presently preferred. It should be understood, however, that the invention is not limited to the precise arrangements and instrumentalities shown.

In the drawings:

FIG. 1 is a perspective view of a aerial camera support structure in accordance with a first preferred embodiment of the present invention;

FIG. 2 is a side view of the aerial camera support structure shown in FIG. 1;

FIG. 3 is a side view of the aerial camera support structure shown in FIG. 1 mounted to a venue;

FIGS. 4 is a side view of the aerial camera support structure shown in FIG. 3 with the camera platform in a retracted position;

FIG. 5 is a side view of the aerial camera support structure shown in FIG. 3 with the camera platform in an extended position;

FIG. 6 is a top plan view of the aerial camera support structure shown in FIG. 3;

FIG. 7 is a top plan view of the aerial camera support structure shown in FIG. 3 in a different horizontal position;

FIG. 8 is a side view of a aerial camera support structure in accordance with a second preferred embodiment of the present invention; and

FIG. 9 is a top plan view of the aerial camera support structure shown in FIG. 8.

### DETAILED DESCRIPTION OF THE INVENTION

Certain terminology is used in the following description for convenience only and is not limiting. The words “inwardly” and “outwardly” refer to directions toward and away from, respectively, the geometric center of a aerial camera support structure in accordance with the present invention, and designated parts thereof. Unless specifically set forth herein, the terms “a”, “an” and “the” are not limited to one element but instead should be read as meaning “at least one”. The terminology includes the words noted above, derivatives thereof and words of similar import.

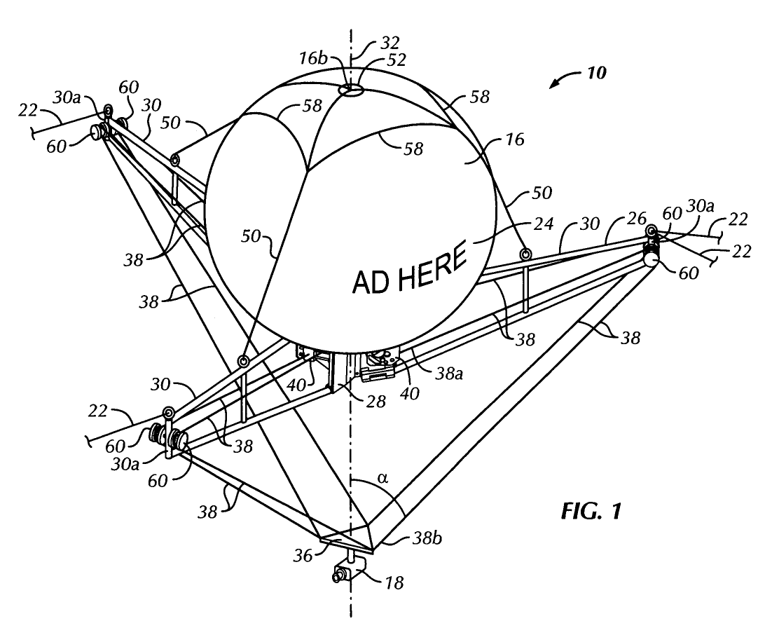

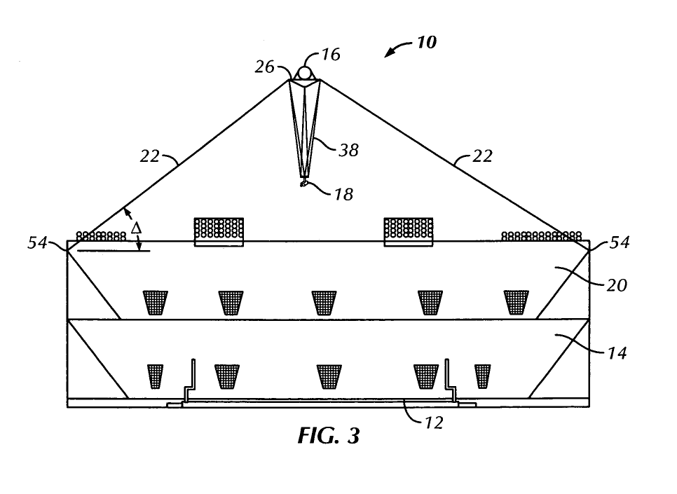

Referring to FIGS. 1-7, the aerial camera support structure (support structure), generally 10, is preferably utilized to capture an image with a camera 18 of an observed area 12 in an indoor or outdoor venue 14 (see FIG. 3). The observed area 12 may be comprised of a field of play such as a football field (shown), a basketball court, a soccer field, a baseball field, a hockey rink, a wrestling mat, a theater stage, a border crossing, a swimming pool, a track, a skating rink, a racetrack, a convention floor or any suitable area for image capture. The aerial support structure 10 may be utilized to capture video and/or still images of the observed area 12 and in any of the seating areas 20 that may be associated with the observed areas 12 such as performing athletes (not shown). Further, the camera 18 may be prompted to capture video and/or still images of any one or more persons (not shown), such as patrons in the seating area 20 of the venue 14, for later sales or other uses, such as TV broadcasts or security purposes.

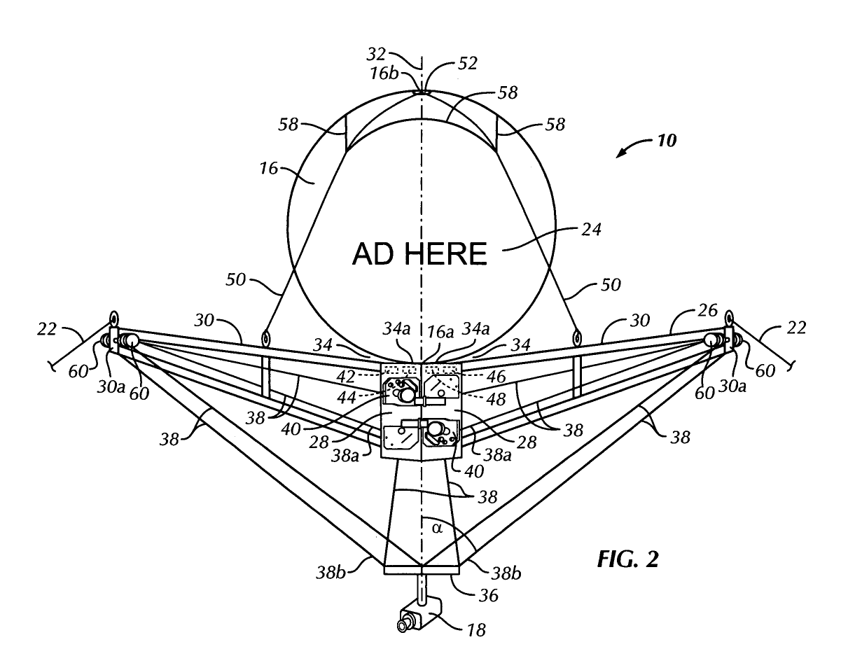

Referring to FIGS. 1 and 2, the camera 18 is suspended from a balloon 16. The balloon 16 is preferably constructed of a relatively durable and light-weight material suitable for retaining appropriate amounts of helium or other lightweight gases as required to provide a sufficient amount of upward force to lower tension otherwise exerted upon transport cables 22 that attach the balloon 18 to the venue 14 as described further below. The balloon 16 may be transparent or colored to match the sky or venue 14 to conceal the presence of the balloon 16 or the balloon 16 may be brightly colored or decorated to attract attention for advertising. The balloon 16 preferably allows the transport cables 22 to have an upward or positive angle A with respect to the observed area 12 (FIG. 3) such that the cables 22 extend downwardly from with respect to the camera 18 rather than the camera sagging at a downward or negative angle (not shown) toward the observed area 12 such that the transport cables 22 extend upwardly with respect to the camera 18. The balloon 16 is sized proportional to the observed area 12 and the amount of load to be carried by the support structure 10. The relative size of the balloon 16 shown in FIGS. 1-7 is for illustration purposes only, is in no way limiting and may be smaller or larger relative to the support structure 10. For example, the balloon 16 may have a diameter that is as large or larger than the remainder of the support structure 10, but may have nearly any diameter that is able to provide lift for the support structure 10.

Additionally, the balloon 16 may operate as an advertising medium. For example, the balloon 17 may have a printed advertisement 24, signage with a backlit image, a projector that projects images onto a banner or other sign, an electronically controlled sign or nearly any other methodology or structure that is able to convey an advertising message to persons, such as patrons within the venue 14. The advertising methods that may be employed upon the balloon 16 may be comprised of nearly any feature or item that is able to convey an advertising message, generally on the balloon 16.

The balloon 16 is preferably attached to a support platform 26. The support platform 26 is preferably used to provide stabilization of the camera 18. The support platform 26 is preferably mounted between the camera 18 and the balloon 16 but the support platform 26 may be mounted around the balloon 16 or on top of the balloon 16. The support platform 26 is preferably constructed of a central support 28 with a plurality of legs 30 extending radially outwardly therefrom. The legs 30 are preferably generally perpendicular to a camera axis 32. The camera axis 32 preferably extends through the camera 18, the central support 28 and the balloon 16. The legs 30 are preferably angled upwardly toward the balloon 16 to form a receiving pocket 34 for the balloon 16 (see FIG. 2). The support platform 26 preferably contacts the balloon 16 axially above the bottom 16a of the balloon 16 and extends axially further toward the top 16b of the balloon 16 such that at least a portion of the support platform 26 is positioned between the bottom, 16a and top 16b of the balloon 16. The receiving pocket 34 allows the support platform 26 to contact the balloon 16 at a contact point 34a radially spaced from the camera axis 32, thereby providing lateral support to the balloon 16. Positioning at least a portion of the support platform 26 between the bottom 16a and top 16b of the balloon 16 also reduces the overall height of the support structure 10 and moves the center of gravity of the support platform 26 closer to the top 16b of the balloon 16 to further increase stability of the support structure 10. The legs 30 are preferably constructed of lightweight aluminum tubing, although the legs 30 may have any shape and be constructed of any suitable lightweight material, such as plastic, and may have any shape such as a ring, diamond or other shape (not shown) that extends around the balloon 16. The support platform 26 preferably has three legs 30. However, the support platform 26 may have additional legs 30 for improved stability or balloon support 16. The geometric center of the support platform 26 is preferably near or on the camera axis 32.

The camera 18 is preferably mounted to a camera platform 36 which is suspended and axially spaced along the camera axis 32 from the support platform 26 by a plurality of support cables 38. A first end 38a of each support cable 38 is mounted to a respective camera winch 40 and a second end 38b is fixed to the camera platform 36. However, the second end 38b of each support cable 38 may be mounted directly to the camera 18. The second end 38b of each support cable 38 preferably extends from the camera platform 36 at an angle α relative to the camera axis 32. The camera 18 is preferably mounted below the camera platform 36. The plurality of winches 40 are mounted to the support platform 26. The winches 40 are preferably mounted to the central support 28 proximate, or near, the camera axis 32 and away from the outer edges of the support platform 26 such that the weight of the winches 40 is closest to the geometric center of the support platform 26 and under the balloon 16. The legs 30 extend generally radially from the central support 28 and are generally evenly spaced from each other at an angle of approximately one hundred twenty degrees (120°). The winches 40 and additional equipment such as a battery 42, a controller 44, a radio frequency device 46 and sensor 48 (shown schematically in FIG. 2) are mounted on the central support 28 proximate the geometric center of the support platform 26 and the camera axis 32, thereby reducing wiring (not shown) needed for the winches 40 and permitting relatively simple modification of the wingspan or size of the support platform 26, such as the size and shape of the legs 26 and the balloon 16 without significant structural modifications to the support platform 26. However, the battery 42, controller 44 and other components may be provided remotely as described below for weight considerations. Providing the winches 40 and other components described above for the various embodiments on the central support 28, positions the center of gravity of the support platform 26 closest or near the geometric center of the support platform 26 to improve the stability of the aerial support structure 26 while allowing the legs 30 to extend outwardly to create the angle α between the camera axis 32 and the support cables 38.

The balloon 16 is preferably mounted to the support platform 26 by a plurality of mounting cables 50. The mounting cables 50 are preferably mounted to one of the legs 30 and are joined to a mounting ring 52 generally positioned on the camera axis 32 and on top of the balloon 16. Support straps 58 preferably extend between the mounting cables 50 to provide for additional lateral support of the balloon 16. The mounting cables 50 may alternatively extend over the balloon 16 and directly attach to another leg 30. However, a net or one or more tether cables (not shown) or part of the support platform 26 may be used to secure the balloon 16 to the support platform 26. The central support 28 and the corresponding components are preferably positioned directly under the balloon 16. However, the central support 28 may be radially expanded with a central aperture (not shown) and the balloon 16 may sit at least partially inside of the central support 28. Room or space to access to the balloon 16 between the mounting cables 50 and legs 30 is preferably provided to allow for deflation and inflation of the balloon 16 as required for maintenance or replacement purposes and such that the advertisement 24 is visible.

The support cables 38 preferably extend from the respective winch 40 along the respective leg 30 to the distal end 30a of the respective leg 30a and downwardly and inwardly to the camera platform 36. A pair of freely rotatable wheels or pulleys 60 are preferably provided at the distal end 30a of each leg 30 and is in contact with the respective support cable 38 to reduce friction between the support cables 38 and the respective leg 30. However, the pulleys 60 may be omitted such that the support cables 38 directly contact the distal end 30a of the respective leg 30 and slide over the distal end 30a or a bar (not shown) of the respective leg 30. Six winches 40 are preferably mounted to the central support 28 to drive the preferred six support cables 38 and manipulate and stabilize the camera platform 28. The central support 28 is not limited to the inclusion of six winches 40 and six support cables 38 and may have nearly any number of winches 40 and support cables 38 as is desired to move the camera platform 36 relative to the central support 28. The support cables 38 preferably extend from the winches 40 at the central support 28 to the distal ends 30a of the legs 30 where they engage the pulleys 60 and then extend to the camera platform 36. The support cables 16 are typically held in tension by the force of gravity due to the suspension of the camera platform 36 from the support platform 26. However, the camera 18 may be suspended from the balloon by a single support cable 38 or the camera 18 may be suspended from the support platform 26 by a rigid or elastic member or pole (not shown) that spaces the camera 18 from the balloon 16.

In comparison to transport cables of a structure wherein the transport cables are fixed at their ends and the camera is suspended therefrom (not shown), the transport cables 22 of the support structure 10 generally support a reduced tension load due to the lift provided by the balloon 16. The effect of reduced tension upon the transport cables 22 enables the support structure 10 to traverse an expanded area of coverage and reduces the structural requirements of the transport cables 22 and their respective anchors 54. The anchors 54 are preferably fixedly attached to the venue 14. However, the anchors 54 may be mounted to a track or other structure (not shown) that allows for movement about the venue 14. The anchors 54 preferably each include a winch (not shown) that controls the movement of the support structure 10 relative to the anchors 54. Each transport cable 22 is preferably fixed to one of the distal ends 30a of the legs 30. However, the transport cables 22 may be mounted to the support structure 10 in any manner such as using a pulley-type configuration or mounted to a support ring (not shown) extending around a perimeter defined by the legs 30. Because the tension is reduced in the transport cables 22 due to the weight support by the balloon 16, an increase in flexibility is achieved which allows the support structure 10 to be exploited over larger distances or areas and allows the anchors 54 to be spaced further from one another.

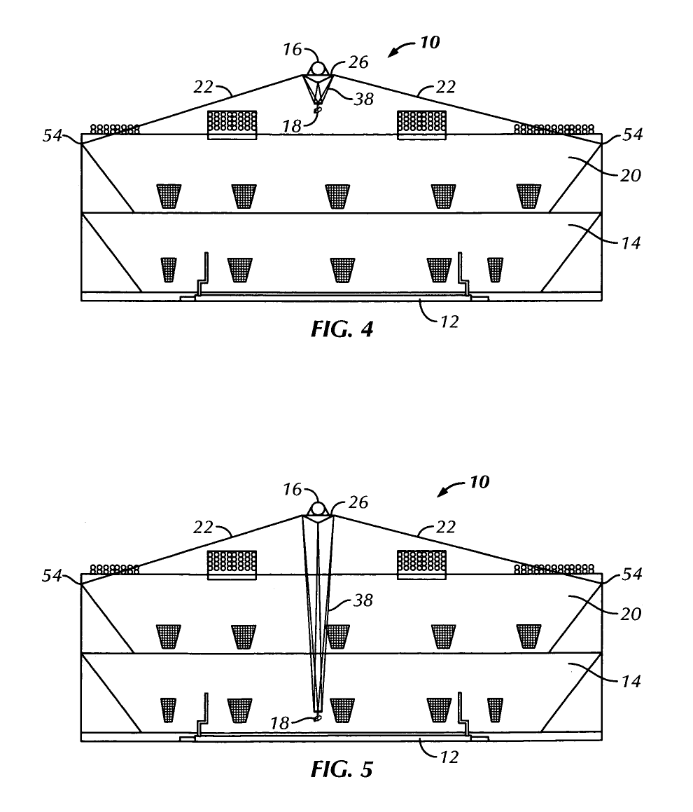

Referring to FIGS. 3-5, as mentioned above, the support platform 26 is preferably positioned above the anchors 54 such that the support platform 26 and balloon 16 are raised above the venue 14 to vary the angle A between zero and ninety degrees. However, the support platform 26 may be configured to sag below the anchors 54 toward the observed area 12 such that the angle Δ is a negative value (not shown) in a more conventional configuration such that the balloon 16 eases but does not eliminate the downward force of the support platform 26 due to the force of gravity on the support platform 26. The transport cables 22 can vary the height of the support platform 26 with respect to the anchors 54 and the venue 14 (see FIGS. 3 and 4 for example). Additionally, the camera 18 can be lowered and raised with respect to the support platform 26 by varying the length of the support cables 38 such that the camera 18 can be held above the venue close to the support platform 26 (FIG. 4) or lowered in close proximity to the observed area 12 (FIG. 5).

When the support platform 26 is positioned above the anchors 54, the sensor 48 may be configured to detect a rapid descent of the support structure 10 if for example, the balloon 16 where to be damaged or otherwise deflate. If the rapid descent is detected, the radio frequency device 46 sends a signal to the anchors 54 to rapidly retract until a certain tension level in the support cables 22 is reached such that the support structure 10 does not fall past the anchors 54 and onto the observed area 12.

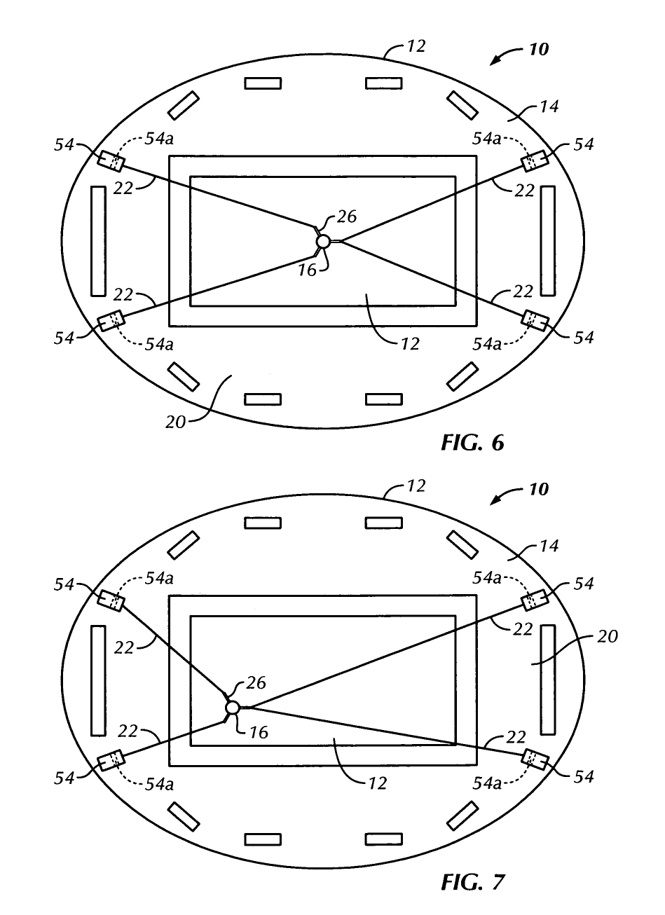

Referring to FIGS. 6 and 7, the transport cables 22 are preferably mounted between an anchor 54 at one end and the distal end 30a of each leg 30 of the support platform 26 at an opposite end. The transport cables 22 may alternatively be attached directly to the balloon 16 rather than the support platform 12. The support structure 10 includes two, and preferably four, transport cables 22 and four respective anchors 54. However, the support structure 10 may be operated with a single transport cable 22 and a single anchor 54, to move vertically on the transport cable and provide relatively wide angle views to a predetermined area. The support structure 10 may include any suitable number of transport cables 22. The transport cables 22 are preferably driven by winches 54a (schematically shown) mounted at the anchors 54 or on the support platform 26 to move the balloon 16 to various locations relative to the venue 12.

The transport cables 22 are preferably constructed of a structural material that is able to support and control movements of the balloon 16 relative to the observed area 12. The transport cables 22 also preferably include a combination of electrical conductors to provide power and/or signals to and between the anchors 54 and the devices of the support structure 10 associated with the support platform 12 and the camera platform 14. In addition, the preferred transport cables 22 include fiber optics (not shown) or similar signal delivery medium to deliver video or other data to and from the support and camera platforms 26, 36 to the ground and/or the controller 44. The electrical conductors and/or fiber optics could be constructed integrally with the transport cables 22 or independently of the transport cables 22, such that, for example, the fiber optic cables do not provide structural support for the balloon 16, but permit transmission of signals from the support and camera platforms 26, 36 to the ground and the controller. Hardwiring the support platform 26 is preferred to mounting the battery 42, controller 44 and radio frequency device 46 directly on the support platform 26 in order to reduce the weight of the support platform 26. In addition, certain of the transport cables 22 may be omitted without significantly impacting the operation and function of the support structure 10, for example, by transmitting signals between the support and camera platforms 12, 14 by wireless technology to the ground and/or the controller 44.

Alternatively, the balloon 16 may be tethered to the support platform 26 by a plurality of support cables (not shown) which extend from the base of the support platform 26 and attach to a plurality of fixtures (not shown) provided on the balloon 16. The support cables 22 provide a secure method of fixing the balloon 16 in the desired location so that tension in the transport cables 22 is reduced.

Further, the balloon 16 may comprise an internal support beam (not shown), extending out from the bottom of the balloon 16 that is attached to the support platform 26. This attachment provides a secure method of distributing the weight of the support platform 26 onto a single, central location on the balloon 16.

In operation, winches (not shown), secured on either the support platform 10 or the anchors 54, controlled by remote, or another suitable control mechanism, are made to extend or shorten the length of the unreeled transport cables 22. The winches 54a are preferably mounted to the anchors 54 for weight considerations but the winches 54a may be provided on the support platform 26. Manipulation of the lengths of each unreeled transport cable 22 will allow the support structure 10 to traverse the area of the venue 14 in multiple dimensions. Specifically, slack or extension in any of the respective transport cables 22 may result in the support structure 10 being moved further from the respective anchor 54 that the transport cable 22 is connected to. Further, such extension may also result in vertical movement of the support structure 10 relative to the venue 14. Manipulation of the lengths of each transport cable 22 result in movement of the support structure 10 to various positions relative to the venue 14 based upon operator preferences.

The support structure 10 may also be employed in an underwater or aquatic environment (not shown). For example, the anchors 54 may be mounted to the floor of a waterway or shipyard, and the balloon may be mounted to an underwater support platform 36 with a camera 18 mounted therefrom. The transport cables 22 may be utilized to move the support platform 26 to positions within the bounds of the anchors 54 to take security video and/or still images of the waterway. Alternatively, the support platform 26 may be fitted with sonar (not shown) or other types of equipment such that the presence or movement of objects in the waterway may be detected by the underwater support structure 10.

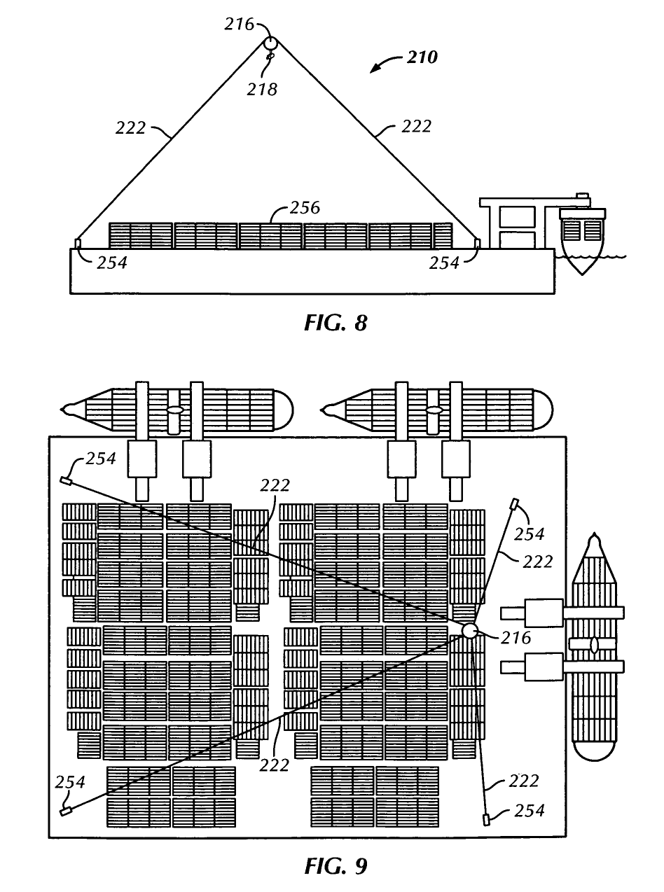

Referring to FIGS. 8 and 9, a second preferred embodiment of the support structure 210 is shown with like reference numerals to indicate like elements in comparison to the above-described first preferred embodiment of the support structure 10 and a leading “2” to distinguish the features of the second preferred embodiment. The second preferred embodiment of the support structure 210 generally simplifies the structure of the first embodiment in that the camera 218 is mounted directly to the balloon 216. However, the camera 218 may be mounted on a platform (not shown) as described above or otherwise mounted to the balloon 216. The camera 218 may be mounted to the balloon 216 such that the camera 218 does not move vertically relative to the balloon 216, or the camera 218 may move vertically relative to the balloon 216 to modify a point-of-view of the camera 218 as described above. The support structure 210 of the second preferred embodiment may be utilized for various applications, such as a sporting event as described above or security or other monitoring of a port or shipyard 256 as shown. The second preferred embodiment of the support structure 210 has a generally simplified structure when compared to the above-described first preferred embodiment of the support structure 10 and may be more appropriate for security and monitoring applications wherein cost considerations and ease of operation are at a premium and the area being monitored is larger than a venue 14.

It will be appreciated by those skilled in the art that changes could be made to the embodiments described above without departing from the broad inventive concept thereof. For example, the preferred embodiment of the support structure 10 of the present invention may be utilized for additional applications other than capturing video and still images at sporting events, such as providing security, video and still images at conventions, aquatic observation and monitoring of hazardous clean-up sites or other like uses. It is understood, therefore, that this invention is not limited to the particular embodiments disclosed, but it is intended to cover modifications within the spirit and scope of the present invention as defined by the appended claims.

I/we claim:

1. An aerial camera support structure for capturing images of objects in an observed area, the aerial support structure comprising:
first and second anchors;
at least one transport cable mounted to at least one of the first and second anchor;
a balloon mounted to the at least one transport cable and movable relative to the first and second anchors; and
a camera suspended from the balloon.

2. The aerial camera support structure of claim 1 further comprising a support platform mounted to the balloon.

3. The aerial camera support structure of claim 2, wherein the support platform includes a central support and a plurality of legs that extend outwardly from the central support.

4. The aerial camera support structure of claim 3 wherein the camera is supported from the support platform by a plurality of support cables, each support cable extends from the camera up to a distal end of a respective leg, along the respective leg to a respective camera winch.

5. The aerial camera support structure of claim 3, wherein the distal end of each leg includes a pulley in contact with a respective support cable.

6. The aerial camera support structure of claim 3, wherein the legs extend axially upwardly toward the balloon to form a pocket in which the balloon sits.

7. The aerial camera support structure of claim 3, wherein a mounting cable extends from each leg and meet generally at the top of the balloon holding the balloon to the support platform.

8. The aerial camera support structure of claim 2 wherein the camera is suspended and axially spaced from the support platform along a camera axis by a plurality of support cables, a first end of each of the support cables being mounted to the support platform and a second end of each of the support cables being fixed to the camera, each of the plurality of support cables defining a support angle relative to the camera axis between the support platform and the camera platform.

9. The aerial camera support structure of claim 8 further comprising:
a plurality of camera winches mounted to the support platform, each of the plurality of camera winches being associated with one of the plurality of support cables, the camera winches operable to move the camera platform relative to the support platform.

10. The aerial camera support structure of claim 9, wherein the winches are mounted proximate the camera axis.

11. The aerial camera support structure of claim 2 wherein the balloon is mounted to the support platform by at least one mounting cable.

12. The aerial camera support structure of claim 2, wherein the support platform is at least partially between a top and bottom of the balloon.

13. The aerial camera support structure of claim 1, wherein a first end of each transport cable is mounted to the respective anchor via a winch and a second end of each transport cable is fixed with respect to the balloon.

14. The aerial camera support structure of claim 1, wherein the camera is movable relative to the balloon.

15. The aerial camera support structure of claim 1, wherein the balloon is filled with helium.

16. The aerial camera support structure of claim 1, wherein the balloon is positioned and moves above the first and second anchors.

17. An aerial camera support structure for capturing images of objects in a venue having a field of play, the aerial camera support structure comprising:
first, second and third anchors fixedly mounted to the venue;
first, second and third transport cables each having a first end mounted to a respective anchor;
a camera axis;
a balloon mounted on the camera axis and to a second end of each of the transport cables, the transport cables moving the balloon relative to the first, second and third anchors above the field of play;
a support platform mounted to the balloon, the support platform positioned at least partially between the bottom and top of the balloon;
a plurality of winches mounted to the support platform; and
a camera suspended and axially spaced from the balloon and the support platform along the camera axis by a plurality of support cables, a first end of each of the support cables being connected to one of the plurality of winches and a second end of each of the support cables being connected to the camera, each of the plurality of support cables defining a support angle relative to the camera axis.
